(19) United States
(12) Patent Application Publication
(10) Pub. No.: US 2022/0113695 A1
(43) Pub. Date: Apr. 14, 2022

(54) ROLLING EARLY WARNING METHOD AND SYSTEM OF DYNAMIC SECURITY RISK SITUATION FOR LARGE SCALE HYBRID AC/DC GRIDS

(71) Applicant: SHANDONG UNIVERSITY, Jinan, Shandong (CN)

(72) Inventors: Yutian LIU, Jinan (CN); Jiongcheng YAN, Jinan (CN); Changgang LI, Jinan (CN)

(73) Assignee: SHANDONG UNIVERSITY, Jinan, Shandong (CN)

(21) Appl. No.: 17/265,852

(22) PCT Filed: Apr. 17, 2020
(86) PCT No.: PCT/CN2020/085397

§ 371 Date: Feb. 4, 2021

(30) Foreign Application Priority Data
Feb. 21, 2020 (CN) 202010107988.7

(51) Int. Cl. G05B 19/042

(52) U.S. Cl. CPC G05B 19/0428; G05B 2219/2639

(57) ABSTRACT

A rolling early warning method and system of dynamic security risk situation for large scale hybrid alternating current/direct current grids, which includes: constructing the original feature set of the fast total transfer capability (TTC) estimation model; generating the training sample set of the fast TTC estimation model based on the network topology and the forecast information of a period of time in the future; constructing the fast TTC estimation model based on stacking denoising autoencoders and extreme learning machine; generating the future operating conditions (OCs), and determine the type of preventive control actions needed to ensure the system security based on the fast TTC estimation model and the heuristic search algorithm; and conducting the layered and hierarchical early warning for OCs according to the type of operating state and the type of preventive control actions that is needed.

### FIELD OF THE INVENTION

The present invention belongs to the field of power system dynamic security risk early warning, and in particular relates to a rolling early warning method and system of dynamic security risk situation for large scale hybrid alternating current/direct current (AC/DC) grids.

### BACKGROUND OF THE INVENTION

With the application of high-capacity high-voltage direct-current (HVDC) transmission technology, modern power systems have become large scale hybrid AC/DC grids. Local short-circuit faults in the AC system can trigger successive commutation failures or blocking of HVDC links, which can result in large scale power flow transfer and huge power imbalance in AC systems, and destroy the security of the whole system. Security risk situation early warning is one of key techniques to safeguard the secure operation of power systems, which performs dynamic security assessment (DSA) for future possible operating conditions (OCs) in advance and identifies high-risk OCs. It can set aside sufficient time and provide valuable decision information for preventive control. Because of the interconnection of power systems and the application of power electronics technology, the scale of power systems is significantly enlarged and the mathematical models of devices are more complex. The computing burden of time-domain simulation is significantly increased, which cannot satisfy the computing time request of online application. Meanwhile, large scale renewable generation is integrated into power systems. Due to the uncertainty of renewable generation, the OC number at the future moment is significantly increased, which further increases the difficulty of early warning.

Existing researches of security risk situation early warning mainly include the method based on severity function, the method based on the unserved MW load, and the method based on control cost. In the method based on severity function, the type and the parameters of the severity functions are chosen by transmission system operators (TSOs) subjectively, which makes the early warning results have insufficient engineering meaning. In the method based on the unserved MW load, the index of the unserved MW load cannot provide valuable decision information for subsequent preventive control. The early warning method based on control cost analyzes the control cost of different types of control actions, and then ranks the OCs according to the type of control actions needed to ensure the system security, which has explicit engineering meaning and can provide valuable decision information for preventive control.

However, the existing early warning method based on control cost has the following shortcomings: (1) HVDC set-point control is one of important control actions of hybrid AC/DC grids, but the existing early warning ranking strategies do not include this control action. (2) After dynamic security constraints are considered, the computing speed of existing early warning methods cannot satisfy the speed request of online application. (3) According to the satisfaction of security constraints, the operating states of power systems are divided into the normal and secure state, the normal and insecure state, and the emergency state, which cannot be reflected by existing early warning ranking results.

### SUMMARY OF THE INVENTION

In order to solve the above shortcomings, the present invention provides a rolling early warning method and system of dynamic security risk situation for large scale hybrid AC/DC grids. Available transfer capability (ATC) is taken as the security margin index of hybrid AC/DC grids. Deep learning technology is deployed to fast evaluate the ATC considering dynamic security constraints. Considering the type of operating state and the type of preventive control actions needed to ensure the system security, the layered and hierarchical early warning is achieved. In the online application, the latest load power forecasts, the latest renewable generation forecasts and the available preventive control resource information are periodically acquired. The early warning results are updated and the rolling early warning is achieved.

To achieve the above purposes, the present invention adopts the following technical scheme.

In the first aspect, the present invention proposes a rolling early warning method of dynamic security risk situation for large scale hybrid AC/DC grids, which includes the following steps:

Construct a fast total transfer capability (TTC) estimation model based on stacking denoising autoencoders (SDAE) and extreme learning machine (ELM). Train the fast TTC estimation model by training samples.

Generate future OCs based on the forecast information of load power and renewable generation.

Determine the type of preventive control actions needed to satisfy the ATC margin constraint by combining the fast TTC estimation model and a heuristic search algorithm.

According to the type of operating state and the type of preventive control actions that is needed, perform the layered and hierarchical early warning for future OCs.

Periodically acquire the latest load power forecasts, the latest renewable generation forecasts and the latest preventive control resource information. Update the early warning results and achieve the rolling early warning.

In the second aspect, the present invention proposes a rolling early warning system of dynamic security risk situation for large scale hybrid AC/DC grids, which includes:

The module of fast TTC estimation model construction, which is used to construct the fast TTC estimation model based on SDAE and ELM, and train the fast TTC estimation model by training samples.

The module of OC set generation, which is used to generate future OCs based on the load forecasts and the renewable generation forecasts.

The module of control cost calculation, which is used to determine the type of preventive control actions needed to satisfy the ATC margin constraint by combining the fast TTC estimation model and a heuristic search algorithm.

The module of early warning ranking, which is used to perform the layered and hierarchical early warning for future OCs according to the type of operating state and the type of preventive control actions that is needed.

The module of rolling update of early warning results, which is used to periodically acquire the latest load power forecasts, the latest renewable generation forecasts and the latest preventive control resource information, update the early warning results, and achieve the rolling early warning.

Compared with the existing technologies, the beneficial effects of the present invention are:

(1) The present invention reasonably analyzes the control cost of HVDC set-point control, and adds this control action into the early warning ranking strategy, which improves the validity of early warning results.

(2) The present invention utilizes the deep learning technique to construct a fast TTC estimation model, which can fast estimate the TTC of given OCs considering multiple dynamic security constraints. As the time-domain simulation is avoided, the early warning results of security risk situation considering dynamic security constraints can be fast determined.

(3) The present invention proposes the layered and hierarchical early warning system considering the type of operating state and the control cost that is needed. Compared with the existing early warning methods based on control cost, the proposed method can reflect the security of OCs more comprehensively, and has explicit engineering meaning.

### BRIEF DESCRIPTION OF THE DRAWINGS

The drawings constituting a part of the present application are used for providing a further understanding of the present application, and illustrative embodiments of the present application and the explanations thereof are used for interpreting the present application, and do not constitute undue limits to the present disclosure.

FIG. 1 illustrates the flowchart of the rolling early warning of dynamic security risk situation for large scale hybrid AC/DC grids.

FIG. 2 illustrates the structure of the fast TTC estimation model.

FIG. 3 illustrates the layered and hierarchical early warning.

FIG. 4 illustrates the flowchart of the early warning rank determination based on the type of preventive control actions that is needed.

FIG. 5 illustrates the flowchart of the rolling update of the early warning results.

FIG. 6 illustrates the diagram of the rolling early warning system of dynamic security risk situation for large scale hybrid AC/DC grids.

### DETAILED DESCRIPTION OF THE EMBODIMENTS

It should be noted that the following detailed descriptions are illustrative and are intended to provide a further description of the present disclosure. Unless otherwise indicated, all technical and scientific terms used herein have the same meanings as commonly understood by those of ordinary skill in the art to which the present application belongs.

It should be noted that the terms used herein are merely for the purpose of describing particular embodiments, rather than limiting the exemplary embodiments of the present disclosure. As used herein, unless otherwise explicitly stated in the context, a singular form is intended to include plural forms. In addition, it should also be understood that when the terms “comprise” and/or “include” are used in the specification, they indicate the presence of features, steps, operations, devices, components, and/or combinations thereof.

### Embodiment 1

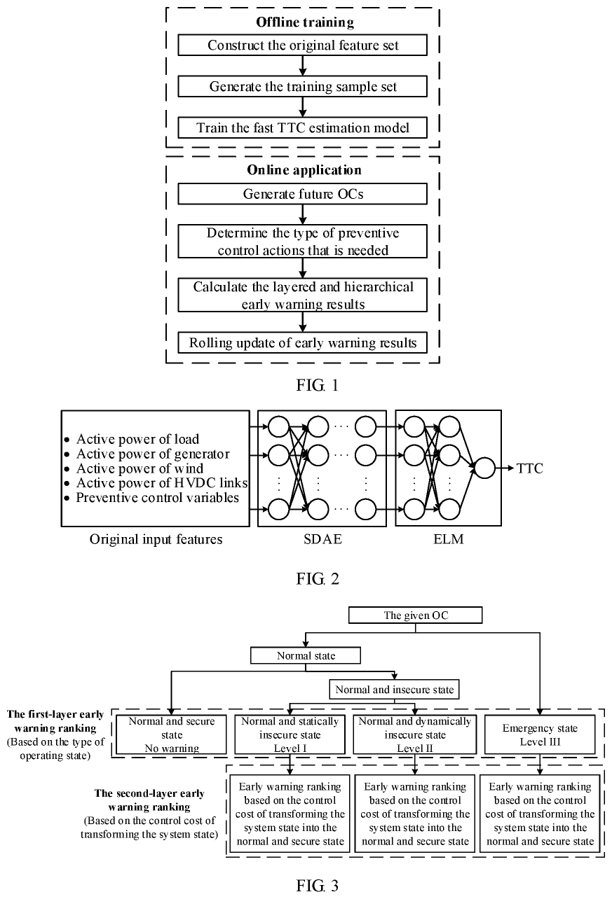

As shown in FIG. 1, the present invention proposes a rolling early warning method of dynamic security risk situation for large scale hybrid AC/DC grids, which includes:

S1: SDAE and ELM are deployed to construct the fast TTC estimation model. The training sample set is utilized to train the fast TTC estimation model.

S2: The future OCs are generated based on the forecast information of load power and renewable generation.

S3: The type of preventive control actions needed to satisfy the ATC margin constraint is determined by combining the fast TTC estimation model and the heuristic search algorithm.

S4: According to the type of operating state and the type of preventive control actions that is needed, the layered and hierarchical early warning is performed for future OCs.

S5: The latest load power forecasts, the latest renewable generation forecasts, and the latest preventive control resource information are periodically acquired. The early warning results are updated and the rolling early warning is achieved.

In S1, the original feature set of the fast TTC estimation model is constructed by considering the operating features relevant to TTC and the control variables of preventive control actions. The original feature set includes the active power of loads, generators, wind farms and HVDC links, the amount of power of generator power re-dispatch, HVDC set-point control and load shedding.

The input features of the fast TTC estimation model need to include all factors influencing TTC. Assuming that load power factors and wind generation power factors are constant, the active power of loads, generators, wind farms and HVDC links is chosen as the features that represent an OC. Additionally, TTC can be improved by preventive control actions. Therefore, control variables of preventive control actions are also chosen as input features.

Hence the input feature set includes the active power of loads, generators, wind farms and HVDC links, and the control variables of preventive control actions. The typical preventive control variables that are considered include the amount of power of generator power re-dispatch, HVDC set-point control and load shedding. The model output is the TTC value of the given OC considering all contingencies.

In S1, the fast TTC estimation model consists of SDAE and ELM. SDAE is used to extract high-level representations from original input features. ELM is utilized to construct the nonlinear mapping relationship between the high-level representations and TTC. The structure of the TTC estimation model is shown in FIG. 2.

Deep learning uses multiple hidden layers to extract high-level representations from original input features, which can improve the accuracy of subsequent regression models. As a typical deep learning model, SDAE has better stability and robustness when facing practical data. Therefore, SDAE is deployed to extract high-level representations in the fast TTC estimation model.

(1) SDAE is constructed by stacking denoising autoencoders (DAEs). The model structure of DAE is the same as the autoencoder. When DAE is trained, the sample data are corrupted by the noise information to make the DAE extract more robust high-level representations.

The activation function of DAE is sigmoid function. The cost function of DAE, denoted as L, is expressed as

$$L ( x , z ) = \frac{1}{2} {‖ x - z ‖}^{2} + λ {\sum }_{i = 1}^{{n}_{1}} {w}_{i}^{2} \qquad ( 1 )$$

where x is the input feature vector; z is the reconstructed feature vector after adding noise to x; λ is the coefficient of regularization; n₁ is the number of weights; wᵢ (1≤i≤n₁) is the weight in DAE that needs to be optimized.

(2) ELM is deployed as the regressor, whose cost function is expressed as

$${L}_{e} = \frac{{C}_{1}}{2} {‖ Y - J {w}_{e} ‖}^{2} + \frac{1}{2} {‖ {w}_{e} ‖}^{2} \qquad ( 2 )$$

where C₁ is the penalty coefficient; Y is the label vector of training samples; J is the output vector of hidden layer; wₑ is the output weight vector of ELM.

By setting the gradient of Lₑ with respect to wₑ to zero, the optimal wₑ, denoted as wₑ, can be expressed as

$${w}_{{e}^{⋆}} = {( {J}^{T} J + \frac{{I}_{h}}{{C}_{1}} )}^{- 1} {J}^{T} Y \qquad ( 3 )$$

where h is the number of hidden neurons of ELM; Iₕ is the identity matrix of dimension h.

In S1, the process of generating the training sample set is as follows:

(a) The load power fluctuation intervals, the wind power fluctuation intervals and the network topology of a period of time in the future are acquired.

(b) The unlabeled samples are generated. Load power and wind power are varied in the fluctuation intervals. Generator power is calculated by predefined dispatching principles. Preventive control variables are varied in predefined variation intervals.

(c) The TTC values of the unlabeled samples are calculated. Continuation power flow is used to verify static security constraints, and time-domain simulation is used to verify dynamic security constraints.

In S1, the training process of the fast TTC estimation model is as follows:

(a) Each hidden layer of SDAE is decoupled and constructed as a DAE. DAEs are trained one by one by unsupervised learning with all training samples.

(b) After SDAE is trained, the high-level representations extracted by SDAE are taken as the new sample features. ELM is trained by supervised learning with all training samples.

In S3, ATC represents the remaining transfer capability of a physical transmission network under a group of security constraints, which is defined as

ATC=TTC−ETC−CBM−TRM (4)

where ETC is existing transfer commitment; CBM is capacity benefit margin; TRM is transmission reliability margin. As CBM and TRM are usually predefined as constants for a given system, they are not considered in the ATC calculation.

The system security is reflected by the index of ATC margin, which is defined as the ratio of ATC to ETC. To guarantee the secure operation of power systems, the ATC margin constraint that needs to be satisfied is

$$\frac{A T C}{E T C} \geq m \qquad ( 5 )$$

where m is the predefined minimum margin value.

In S3, the process of determining the type of preventive control actions needed to satisfy the ATC margin constraint by the heuristic search algorithm is as follows.

(1) Control sensitivities of every control variable to the ATC margin are approximately calculated. First, a certain control variable is changed with a small increment. Then, the variation of TTC is calculated by the TTC estimation model, and the variation of the ATC margin is calculated.

(2) All control variables, whose control sensitivities exceed predefined sensitivity thresholds, are changed a step toward the direction of improving the ATC margin.

(3) Control variables are checked to judge whether to exceed control limits. If a control variable exceeds the predefined control limit, the control variable is set as the corresponding upper or lower limit.

(4) Loop termination conditions are checked. If one of termination conditions is satisfied, the search process is terminated.

The termination conditions include: a) An available control scheme is searched out. b) The maximum iterative number is reached. c) After the calculation of the control sensitivities, the control sensitivities of all control variables do not exceed the predefined sensitivity thresholds.

In S4, the diagram of layered and hierarchical early warning is shown in FIG. 3. After the contingency set is given, if the system satisfies the ATC margin constraint, the system is in the normal and secure state. If the system cannot satisfy the ATC margin constraint due to the restriction of static security constraints, the system is in the normal and statically insecure state. If the system cannot satisfy the ATC margin constraint due to the restriction of dynamic security constraints, the system is in the normal and dynamically insecure state. If the system cannot satisfy the static security constraints in the static operating point before contingencies happen, the system is in the emergency state.

The first-layer early warning ranking is performed according to the type of operating state of the power system. In increasing order of insecurity, the ranking strategy is:

No warning: The system is in the normal and secure state.

Level I: The system is in the normal and statically insecure state.

Level II: The system is in the normal and dynamically insecure state.

Level III: The system is in the emergency state.

After the first-layer early warning ranking is finished, if the system is not in the normal and secure state, the second-layer early warning ranking is conducted, which is based on the type of preventive control actions needed to satisfy the ATC margin constraint. Three typical preventive control actions are considered, which include intra-area generator power re-dispatch, inter-area HVDC set-point control and load shedding. In general, intra-area power re-dispatch does not change inter-area power transactions, which has lower control cost than inter-area HVDC set-point control. Load shedding can lead to large economic loss and negative social impacts, which has the highest control cost. Based on the above analysis, in increasing order of insecurity, the ranking strategy is:
Level 1: Intra-area generator power re-dispatch is needed.
Level 2: Inter-area HVDC set-point control is needed.
Level 3: Load shedding is needed.
Level 4: ATC margin constraint cannot be satisfied even by the best combination of available preventive control actions.

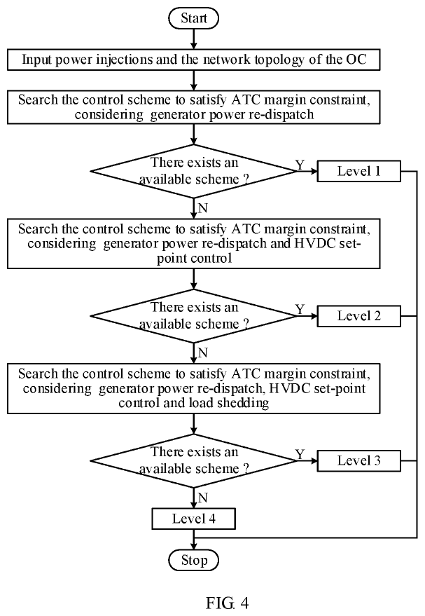

The flowchart of early warning ranking determination based on the type of preventive control actions that is needed is shown in FIG. 4. Optimal power flow (OPF) has been used to calculate the type of control actions needed to satisfy security constraints. As ATC is restricted by dynamic security constraints, it is difficult to express the ATC margin constraint in OPF analytically. Therefore, a heuristic algorithm is used to determine the rank of the second-layer early warning. The core step in FIG. 4 is to consider certain types of preventive control actions and search for a preventive control scheme to satisfy the ATC margin constraint.

In S5, the flowchart of rolling update of early warning results is shown in FIG. 5. The process of rolling early warning is:

(1) After the forecasts of load power and renewable generation are periodically updated, acquire the latest forecast information and the latest preventive control resource information.

(2) Generate the future OC set for early warning based on the latest forecast information.

(3) Determine the first-layer early warning results for the future OCs that are generated.

(4) Determine the second-layer early warning results for the future OCs.

(5) Periodically update the previous early warning results.

(6) If the forecast information will be periodically updated again, wait for the next update. Otherwise, the process of the rolling early warning is stopped.

In the actual power system operation, the forecast information of load power and renewable generation will be updated periodically after a period of time. The available preventive control resources will also continuously change. The forecast information of load power and renewable generation will become more accurate along with the rolling update, and the uncertainty will decrease. Performing the early warning calculation based on the latest forecast information can also improve the accuracy of early warning results. After the forecast information of load power and renewable generation is periodically updated, this embodiment updates the previous early warning results based on the latest forecast information and the latest preventive control resource information, and achieves the rolling early warning.

### Embodiment 2

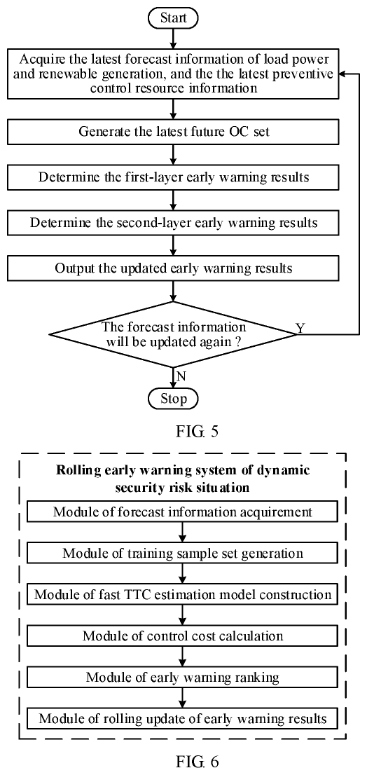

As shown in FIG. 6, the present invention proposes a rolling early warning system of dynamic security risk situation for large scale hybrid AC/DC grids, which includes:

The module of fast TTC estimation model construction, which is used to construct the fast TTC estimation model based on SDAE and ELM, and train the fast TTC estimation model by training samples.

The module of control cost calculation, which is used to determine the type of preventive control actions needed to satisfy the ATC margin constraint by combining the fast TTC estimation model and a heuristic search algorithm.

The module of early warning ranking, which is used to perform the layered and hierarchical early warning for future OCs according to the type of operating state and the type of preventive control actions that is needed.

The module of rolling update of early warning results, which is used to periodically acquire the latest load power forecasts, the latest renewable generation forecasts and the latest preventive control resource information, perform the early warning calculation repeatedly, update the early warning results, and achieve the rolling early warning.

The module of fast TTC estimation model construction also includes: The sub-module of forecast information acquirement, which is used to acquire the network topology, the load power forecast intervals, the renewable generation forecast intervals and the variation intervals of the preventive control variables of a period of time in the future.

The sub-module of training sample set generation, which is used to generate many possible OCs and calculate their TTC values based on the relevant forecast information, in order to generate the training sample set.

In the sub-module of training sample set generation, the training sample set generation includes:

(1) The load power fluctuation intervals, the wind power fluctuation intervals and the network topology of a period of time in the future are acquired.

(2) The unlabeled samples are generated. Load power and wind power are randomly varied in the fluctuation intervals. Generator power is calculated by predefined dispatching principles. Preventive control variables are randomly varied in predefined variation intervals.

(3) The TTC values of the unlabeled samples are calculated. Continuation power flow is used to verify static security constraints, and time-domain simulation is used to verify dynamic security constraints.

In the module of fast TTC estimation model construction, the training process of the fast TTC estimation model is:

(1) Each hidden layer of SDAE is decoupled and constructed as a DAE. DAEs are trained one by one by unsupervised learning with all training samples.

(2) After SDAE is trained, the high-level representations extracted by SDAE are taken as the new sample features. ELM is trained by supervised learning with all training samples.

In the module of control cost calculation, ATC represents the remaining transfer capability of a physical transmission network under a group of security constraints, which is defined as

ATC=TTC−ETC−CBM−TRM (6)

where CBM is capacity benefit margin; TRM is transmission reliability margin. As CBM and TRM are usually predefined as constants for a given system, they are not considered in the ATC calculation.

The system security is reflected by the index of ATC margin, which is defined as the ratio of ATC to ETC. To guarantee the secure operation of power systems, the ATC margin constraint that needs to be satisfied is

$$\frac{A T C}{E T C} \geq m \qquad ( 7 )$$

where m is the predefined minimum margin value.

In the module of control cost calculation, the heuristic search algorithm includes:

(1) Control sensitivities of every control variable to the ATC margin are approximately calculated. First, a certain control variable is changed with a small increment. Then, the variation of TTC is calculated by the TTC estimation model, and the variation of the ATC margin is calculated.

(2) All control variables, whose control sensitivities exceed predefined sensitivity thresholds, are changed a step toward the direction of improving the ATC margin.

(3) Control variables are checked to judge whether to exceed control limits. If a control variable exceeds the predefined control limit, the control variable is set as the corresponding upper or lower limit.

(4) Loop termination conditions are checked. If one of termination conditions is satisfied, the search process is terminated.

The termination conditions include: a) An available control scheme is searched out. b) The maximum iterative number is reached. c) After the calculation of the control sensitivities, the control sensitivities of all control variables do not exceed the predefined sensitivity thresholds.

In the module of early warning ranking, the first-layer early warning ranking is performed according to the type of operating state of the power system. In increasing order of insecurity, the ranking strategy is:

No warning: The system is in the normal and secure state.

Level I: The system is in the normal and statically insecure state.

Level II: The system is in the normal and dynamically insecure state.

Level III: The system is in the emergency state.

After the first-layer early warning ranking is finished, if the system is not in the normal and secure state, the second-layer early warning ranking is conducted, which is based on the type of preventive control actions needed to satisfy the ATC margin constraint. Three typical preventive control actions are considered, which include intra-area generator power re-dispatch, inter-area HVDC set-point control and load shedding. In general, intra-area power re-dispatch does not change inter-area power transactions, which has lower control cost than inter-area HVDC set-point control. Load shedding can lead to large economic loss and negative social impacts, which has the highest control cost.

Based on the above analysis, in increasing order of insecurity, the ranking strategy is:

Level 1: Intra-area generator power re-dispatch is needed.

Level 2: Inter-area HVDC set-point control is needed.

Level 3: Load shedding is needed.

Level 4: ATC margin constraint cannot be satisfied even by the best combination of available preventive control actions.

In the module of rolling update of early warning results, the process of the rolling early warning is:

(1) After the forecasts of load power and renewable generation are periodically updated, acquire the latest forecast information and the latest preventive control resource information.

(2) Generate the future OC set for early warning based on the latest forecast information.

(3) Determine the first-layer early warning results for the future OCs that are generated.

(4) Determine the second-layer early warning results for the future OCs.

(5) Periodically update the previous early warning results.

(6) If the forecast information will be periodically updated again, wait for the next update. Otherwise, the process of the rolling early warning is stopped.

In the actual power system operation, the forecast information of load power and renewable generation will be updated periodically after a period of time. The available preventive control resources will also continuously change. The forecast information of load power and renewable generation will become more accurate along with the rolling update, and the uncertainty will decrease. Performing the early warning calculation based on the latest forecast information can also improve the accuracy of early warning results. After the forecast information of load power and renewable generation is periodically updated, this embodiment updates the previous early warning results based on the latest forecast information and the latest preventive control resource information, and achieves the rolling early warning.

Although the detailed embodiments of the present invention are described above in combination with the accompanying drawings, the protection scope of the present invention is not limited thereto. It should be understood by those skilled in the art that various modifications or variations could be made by those skilled in the art based on the technical solution of the present invention without any creative effort, and these modifications or variations shall fall into the protection scope of the present invention.

1. A rolling early warning method of dynamic security risk situation for large scale hybrid alternating current/direct current (AC/DC) grids, the method comprising:
construct a fast total transfer capability (TTC) estimation model based on stacking denoising autoencoders (SDAE) and extreme learning machine (ELM); train the fast TTC estimation model by training samples;
generate future operating conditions (OCs) based on forecast information of load power and renewable generation;
determine the type of preventive control actions needed to satisfy an available transfer capability (ATC) margin constraint by combining the fast TTC estimation model and a heuristic search algorithm;
according to type of operating state and type of preventive control actions that is needed, perform layered and hierarchical early warning for future OCs;
periodically acquire latest load power forecasts, latest renewable generation forecasts and latest preventive control resource information; update early warning results and achieve rolling early warning.

2. The method of claim 1, wherein, a process of generating the training sample set is:
load power fluctuation intervals, wind power fluctuation intervals and network topology of a period of time in the future are acquired;
unlabeled samples are generated; load power and wind power are randomly varied in the fluctuation intervals; generator power is calculated by predefined dispatching principles; preventive control variables are randomly varied in predefined variation intervals;
TTC values of the unlabeled samples are calculated; continuation power flow is used to verify static security constraints, and time-domain simulation is used to verify dynamic security constraints.

3. The method of claim 1, wherein, an original feature set of the fast TTC estimation model is constructed by considering operating features relevant to TTC and control variables of preventive control actions; the original feature set includes active power of loads, generators, wind farms and high-voltage direct-current (HVDC) links, amount of power of generator power re-dispatch, HVDC set-point control and load shedding.

4. The method of claim 1, wherein, in the fast TTC estimation model, SDAE is used to extract high-level representations from original input features; ELM is utilized to construct nonlinear mapping relationship between the high-level representations and TTC; model output is TTC value of a given OC considering all contingencies.

5. The method of claim 1, wherein, a training process of the fast TTC estimation model is:
each hidden layer of SDAE is decoupled and constructed as a denoising autoencoder (DAE); DAEs are trained one by one by unsupervised learning with all training samples;
after SDAE is trained, high-level representations extracted by SDAE are taken as new sample features; ELM is trained by supervised learning with all training samples.

6. The method of claim 1, wherein, ATC margin is defined as ratio of ATC to existing transfer commitment (ETC); the ATC margin constraint that needs to be satisfied is
$$\frac{A T C}{E T C} \geq m \qquad ( 8 )$$
where m is a predefined minimum margin value.

7. The method of claim 1, wherein, a process of determining the type of preventive control actions needed to satisfy the ATC margin constraint is:
control sensitivities of every control variable to the ATC margin are approximately calculated; first, a certain control variable is changed with a small increment; then, variation of TTC is calculated by the TTC estimation model, and variation of the ATC margin is calculated;
all control variables, whose control sensitivities exceed predefined sensitivity thresholds, are changed a step toward direction of improving the ATC margin;
control variables are checked to judge whether to exceed control limits; if a control variable exceeds predefined control limit, the control variable is set as corresponding upper or lower limit;
loop termination conditions are checked, if one of termination conditions is satisfied, the search process is terminated.

8. The method of claim 1, wherein, a process of rolling early warning is:
after forecasts of load power and renewable generation are periodically updated, acquire latest forecast information and latest preventive control resource information;
generate a future OC set for early warning based on the latest forecast information;
determine first-layer early warning results and second-layer early warning results for future OCs that are generated;
periodically update the previous early warning results; if the forecast information will be periodically updated again, wait for the next update; otherwise, the process of the rolling early warning is stopped.

9. The method of claim 1, wherein, a process of layered and hierarchical early warning is:
first-layer early warning ranking is performed according to type of operating state of a power system; in increasing order of insecurity, a ranking strategy includes:
no warning, level I, level II, and level III;
after the first-layer early warning ranking is finished, if the power system is not in a normal and secure state, second-layer early warning ranking is conducted, which is based on type of preventive control actions needed to satisfy the ATC margin constraint; a ranking strategy is:
level 1: intra-area generator power re-dispatch is needed;
level 2: inter-area HVDC set-point control is needed;
level 3: load shedding is needed;
level 4: ATC margin constraint cannot be satisfied even by a best combination of available preventive control actions.

10. A rolling early warning system of dynamic security risk situation for large scale hybrid AC/DC grids, the system comprising:
a module of fast TTC estimation model construction, which is used to construct the fast TTC estimation model based on SDAE and ELM, and train the fast TTC estimation model by training samples;
a module of OC set generation, which is used to generate future OCs based on load forecasts and renewable generation forecasts;
a module of control cost calculation, which is used to determine the type of preventive control actions needed to satisfy the ATC margin constraint by combining the fast TTC estimation model and a heuristic search algorithm;
a module of early warning ranking, which is used to perform the layered and hierarchical early warning for future OCs according to the type of operating state and the type of preventive control actions that is needed;
a module of rolling update of early warning results, which is used to periodically acquire latest load power forecasts, latest renewable generation forecasts and latest preventive control resource information, update early warning results, and achieve rolling early warning.
